(19) United States
(12) Patent Application Publication
(10) Pub. No.: US 2013/0322705 A1
(43) Pub. Date: Dec. 5, 2013

(54) FACIAL AND FINGERPRINT AUTHENTICATION

(71) Applicant: Warwick Ka Kui Wong, Palo Alto, CA (US)

(72) Inventor: Warwick Ka Kui Wong, Palo Alto, CA (US)

(73) Assignee: Google Inc., Mountain View, CA (US)

(21) Appl. No.: 13/483,292

(22) Filed: May 30, 2012

(51) Int. Cl. G06K 9/68; G06T 1/00

(52) U.S. Cl. 382/118; 340/5.83; 348/E07.085

(57) ABSTRACT

A facial and fingerprint authentication technique is used to unlock a device. For example, the device may be configured to capture facial image of a user utilizing a first camera and a fingerprint of the user utilizing a second camera. The device may also be configured to compare the captured facial image with a reference facial image, and compare the captured fingerprint with a reference fingerprint. The device may further be configured to unlock a device when the captured facial image matches the reference facial image and the captured fingerprint matches the reference fingerprint.

### FIELD

The present disclosure generally pertains to facial and fingerprint authentication, and more specifically, to authentication of a user utilizing a facial and fingerprint authentication technique.

### BACKGROUND

Generally, a device, such as a mobile phone, a personal digital assistant (PDA), a desktop, a laptop, a tablet, etc., may have mechanisms to prevent access by a user other than the registered user. Such mechanisms may include password protection, fingerprint authentication, or facial recognition tools. However, facial recognition by itself may not be a sufficiently secure means to prevent access by other users of the device. For increased security, it may be beneficial to simultaneously capture facial recognition data and fingerprint recognition data to authenticate a user of the device.

### SUMMARY

Certain implementations of the present disclosure may provide solutions to the problems and needs in the art that have not yet been fully solved by conventional authentication mechanisms or processes. For example, certain implementations pertain to capturing a facial image of a user and a fingerprint of the user to authenticate a user prior to unlocking the device.

In one implementation, a computer program is embodied on a computer-readable storage medium. The computer program is configured to cause a processor to capture a facial image of a user utilizing a first camera and a fingerprint of the user utilizing a second camera. The processor is further configured to compare the captured facial image with a reference facial image, and compare the captured fingerprint with a reference fingerprint. The processor is also configured to unlock a device when the captured facial image matches the reference facial image and the captured fingerprint matches the reference fingerprint.

In another implementation, a computer-implemented process includes capturing a fingerprint of a user's finger, and a facial image of the user. The computer-implemented process also includes authenticating the user based on the captured fingerprint and the facial image of the user. The computer-implemented process further includes unlocking the device when the captured fingerprint and the facial image of the user are authenticated.

In yet another implementation, an apparatus includes physical memory comprising computer program instructions, and a processor configured to execute the computer program instructions. The processor is configured to capture a fingerprint of a user's finger, and a facial image of the user. The processor is further configured to authenticate the user based on the captured fingerprint and the facial image of the user. The processor is also configured to unlock the apparatus when the captured fingerprint and the facial image of the user are authenticated.

In a further implementation, a computer-implemented process includes capturing, by a device, a gesture of a user's finger, and a facial image of the user. The computer-implemented process also includes authenticating, by the device, the user based on the captured gesture and the facial image of the user. The computer-implemented process further includes unlocking the device when the captured gesture and the facial image of the user are authenticated.

In yet a further implementation, an apparatus includes physical memory comprising computer program instructions, and a processor configured to execute the computer program instructions. The processor is configured to capture a gesture of a user's finger and a facial image of the user. The processor is also configured to authenticate the user based on the captured gesture and the facial image of the user. The processor is further configured to unlock the apparatus when the captured gesture and the facial image of the user are authenticated.

### BRIEF DESCRIPTION OF THE DRAWINGS

In order that the advantages of certain implementations of the present disclosure will be readily understood, a more particular description of the apparatuses, processes, and computer programs briefly described above will be rendered by reference to specific implementations that are illustrated in the appended drawings. While it should be understood that these drawings depict only typical implementations of the apparatuses, processes, and computer programs, and are not therefore to be considered to be limiting of its scope, the apparatuses, processes, and computer programs will be described and explained with additional specificity and detail through the use of the accompanying drawings, in which:

FIG. 1 illustrates a process for unlocking a device using facial and fingerprint authentication, according to an implementation of the present disclosure.

FIG. 2 illustrates a process for performing an unlocking function on the device using facial and fingerprint authentication, according to an implementation of the present disclosure.

FIG. 3 illustrates a process for capturing movement of the user's finger to select one or more applications, according to an implementation of the present disclosure.

FIGS. 4A and 4B illustrate a mobile device, according to an implementation of the present disclosure.

FIG. 5 illustrates a system for unlocking a device using facial and fingerprint authentication, according to an implementation of the present disclosure.

### DETAILED DESCRIPTION

One or more implementations described herein pertain to unlocking a device by using a facial and fingerprint authentication technique. For example, the device may be configured to simultaneously capture a facial image and a fingerprint of a user in order to unlock the device. Some devices, such as a mobile phone or a PDA, have two cameras—a front (or first) camera and a rear (or second) camera. The first camera can capture the facial image of the user, and the second camera can capture the fingerprint of the user, simultaneously in some implementations. In certain implementations, the second camera may include a macro-mode with auto-focus and a built-in flash and/or light-emitting diodes (LEDs) to provide sufficient lighting to capture the fingerprint when the user places his or her finger on the second camera. In an alternative implementation, a biometric sensor may be configured to capture the fingerprint of the user.

In certain implementations, the first and second camera can contemporaneously capture a first image and a second image for authentication of the user. The first and/or second image may be a facial image, a fingerprint, a motion, a gesture, or any other object and/or movement thereof that would be appreciated by a person of ordinary skill in the art. For example, the first camera may capture a facial image and the second camera may capture an object, such as a shoe, for authenticating the user. In another example, the first camera may capture a fingerprint and the second camera may capture an object, such as a watch, to authenticate the user. However, any object may be used.

The device can be unlocked, or the user can have access to the device, when both facial and fingerprint authentication are conducted at the same time. By utilizing such a technique, it would be difficult to simply use, for example, a photograph of the user and obtain a fingerprint of the user to access the device.

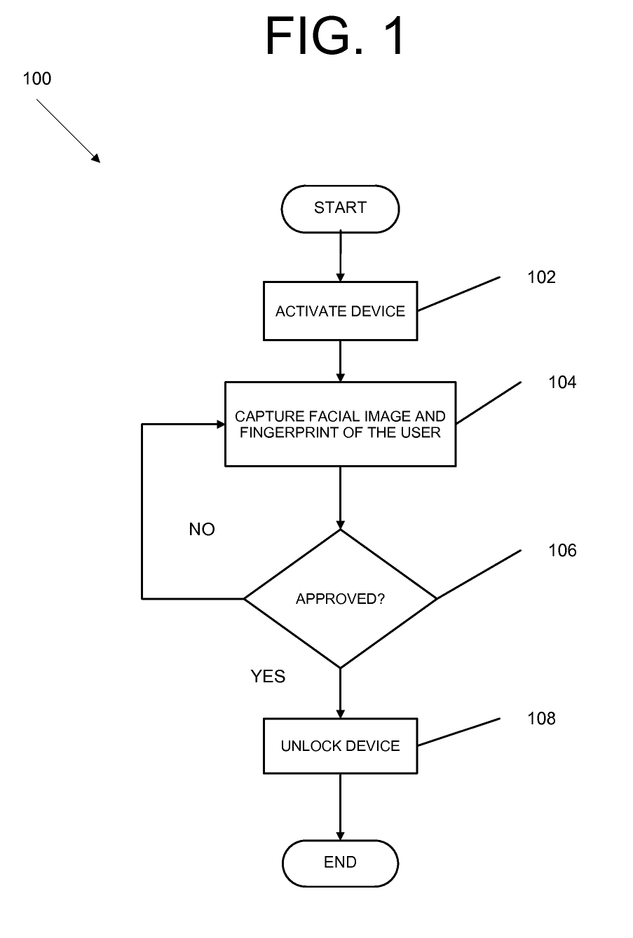

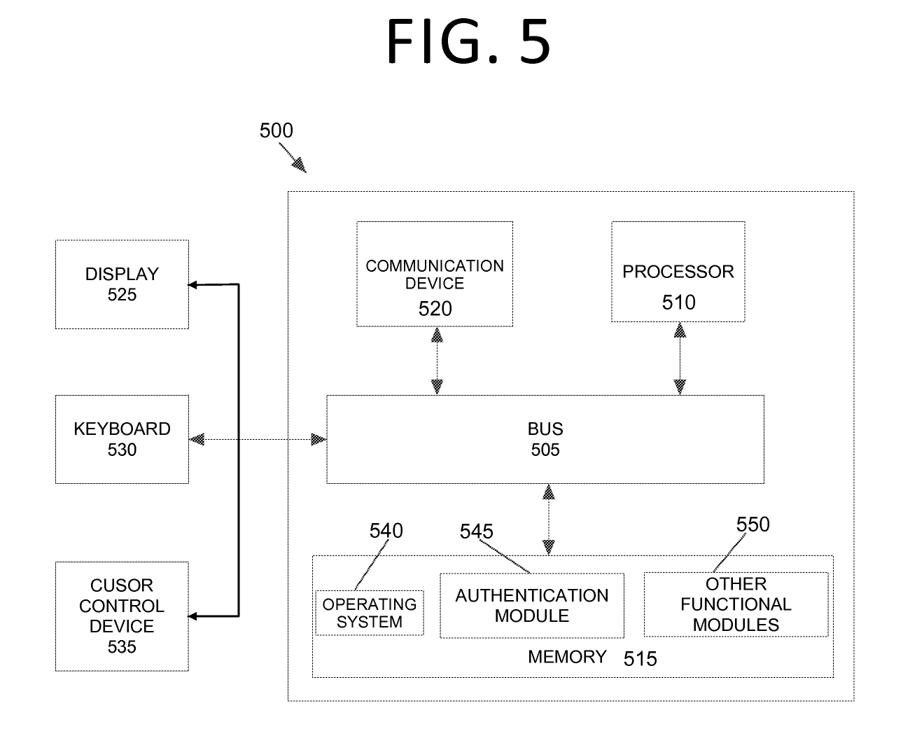

FIG. 1 illustrates a process 100 for unlocking a device using facial and fingerprint authentication, according to an implementation of the present disclosure. In some implementations, the process of FIG. 1 may be performed by, for example, the system of FIG. 5. The process begins with activating the device at 102, such as when the user presses the button to turn on the device from an off state or a sleep mode state. Because the device is in a locked state and cannot be accessed, the device may require the user to submit authentication information, such as a facial image and a fingerprint of the user. The first and second camera on the device may capture such authentication information. For example, at 104, a first camera of the device may capture the facial image of the user and a second camera of the device may simultaneously capture the fingerprint of the user. For example, when a user places his or her finger near or on the second camera, the first camera may capture the facial image of the user and the second camera may capture the fingerprint of the user. The capturing of the facial image and the fingerprint may occur either simultaneously, or in a sequential order, potentially in rapid succession. In certain implementations, the facial image and the fingerprint of the user may be captured in sequential order.

At 106, the device determines whether the captured facial image and the captured fingerprint of the user are approved. That is, the device determines whether the user has been granted access. For example, a computer program may be configured to cause a processor to compare the captured facial image of the user with a reference facial image stored within memory of the device. Simultaneously, the processor may also compare the captured fingerprint of the user with a reference fingerprint stored within the memory of the user.

In an alternative implementation, the processor may convert the captured facial image into a file of features of the facial image, and convert the fingerprint image into a file of features of the fingerprint, such as primitive, a live scan, or the like. The processor may then compare data extracted from the obtained fingerprint to reference fingerprint data, and compare data extracted from the facial image to reference facial data to determine whether the user is authorized.

If the processor determines that the captured facial image and fingerprint of the user do not match the stored reference facial image and reference fingerprint, then step 104 is repeated and the first and second camera may capture the facial image and fingerprint of the user, respectively. If the processor determines that the captured facial image and fingerprint of the user match the stored reference facial image and reference fingerprint, then the device is unlocked at 108 and the user is granted access to utilize the device to call another device, transmit messages, access applications stored on the device, etc.

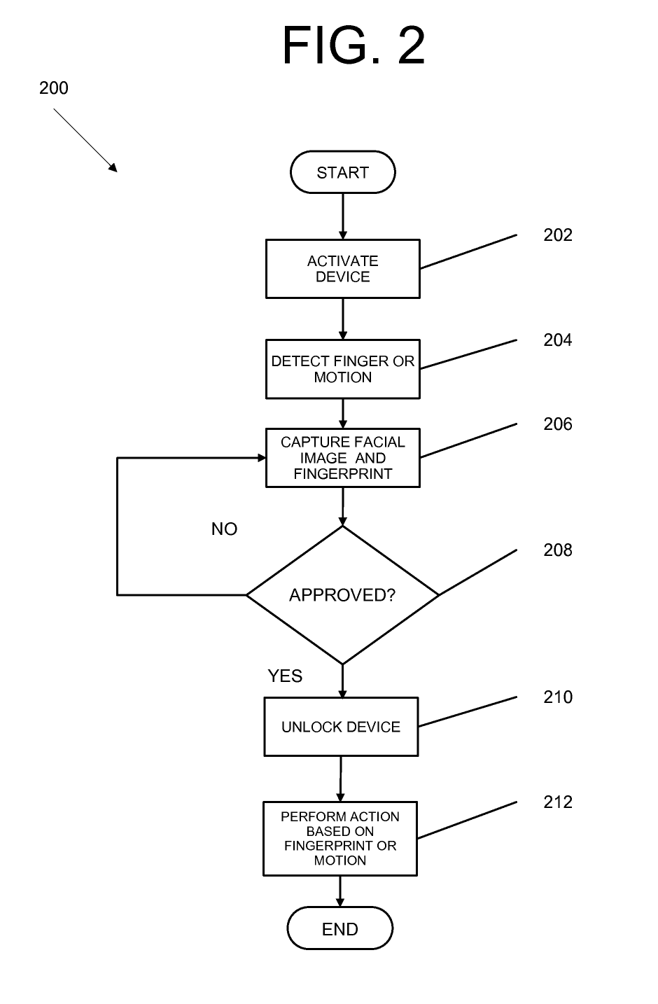

In certain implementations, the device can be configured to carry out a particular action after the device is unlocked based on the fingerprint and/or motion of the user's finger, or based on the facial image of the user. FIG. 2, for example, illustrates a process 200 for performing a function on the device using facial and fingerprint authentication, according to an implementation of the present disclosure. In some implementations, the process of FIG. 2 may be performed by, for example, the system of FIG. 5.

At 202, the device is activated or turned on when the user presses the on button. In order to allow the user to utilize the device, the user may be required to submit a facial image and a fingerprint of the user. It should be appreciated that in an alternative implementation process 200 may be configured to begin at 204. At 204, in order to capture a fingerprint of the user and the facial image of the user, the second camera is configured to automatically detect whether the user has placed his or her finger on the second camera or whether the user performed a particular motion with his or her finger. The particular motion may include, for example, a circular motion, a rectangular motion, a swipe motion (up, down, left, right motion), a combination of different swipe motions, or any motion that would be appreciated by a person of ordinary skill in the art. Such motions may be pre-stored in the device and configured by the user. For example, the user may use a circular motion to indicate that the user wants to message another device, a rectangular motion may indicate that the user wants to place a call, etc.

At 206, upon detection of the finger or motion of the user's finger, the first and second camera may capture the facial image of the user and the fingerprint or motion of the user's finger, respectively. At 208, a computer program stored on the device may cause the processor to determine whether the user has been approved or authenticated. For example, the processor may compare the facial image of the user with a reference facial image that was stored on a memory of the device. Similarly, the processor may compare the fingerprint or motion of the user's finger with a reference fingerprint or reference motion of the user's finger that was stored on the memory of the device.

If the processor determines that the user is not approved to utilize the device, then step 206 is repeated and the facial image and fingerprint or motion of the user's finger is captured again. If the processor determines that the user is approved, then the device is unlocked at 210. At 212, the computer program may cause the processor to execute a particular function on the device based on the captured fingerprint of the user, the captured motion of the user's finger, and/or the captured facial image of the user. Lets say, for example, that a circular motion indicates that a message can be sent. If the user made a circular motion with his or her finger when the second camera captured the motion, upon unlocking of the device, a message application may be launched for the user to access. Once the user has transmitted the message, the device may return to a locked state or remain unlocked depending on the configuration of the device.

In an alternative implementation, depending on the fingerprint that was captured, a particular action may be carried out when the device is unlocked. For example, a fingerprint of an index finger may indicate that a call is to be placed. When the fingerprint of the user's index finger is captured at step 206, when the device is unlocked, a telephone application may be launched to allow the user to place a call after the device has been unlocked.

It should be appreciated that the device may have a plurality of fingerprints or motions and facial images registered for each user. Depending on the user and his or her access level, certain applications may be accessed or displayed.

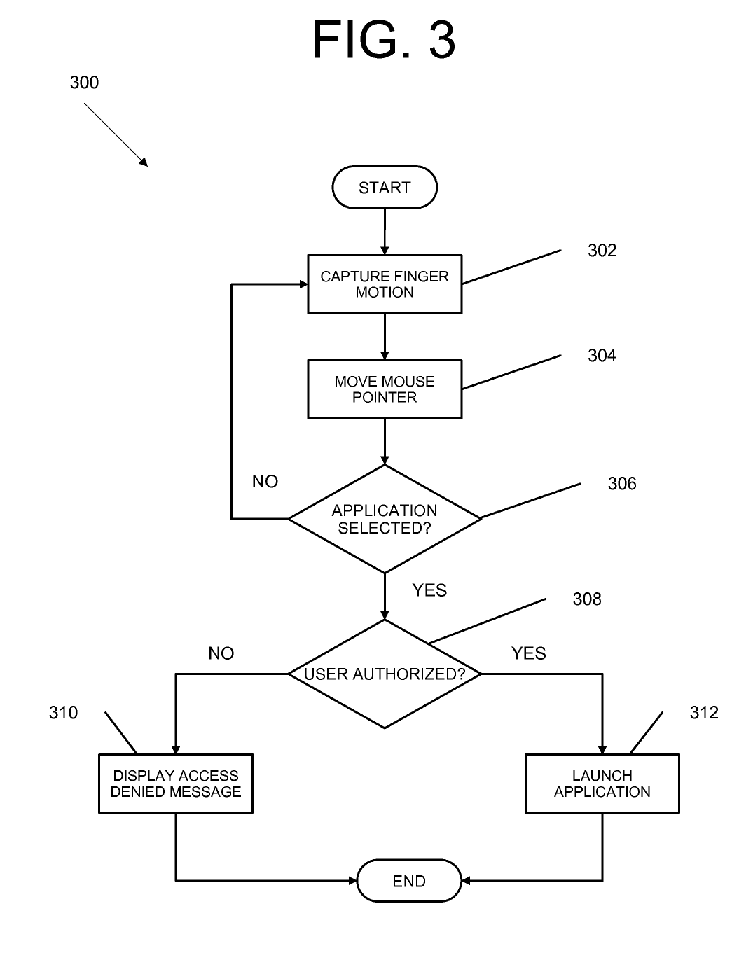

In certain implementations, once the device has been unlocked, the user may use his or her finger as a pointer to select an application on the device. FIG. 3, for example, illustrates a process 300 for capturing movement of the user's finger to select one or more applications, according to an implementation of the present disclosure. In some implementations, the process of FIG. 3 may be performed, for example, by the system of FIG. 5.

Once the device has been unlocked, the second camera may capture the motion of the user's finger at 302 to allow the user to use his or her finger as a pointer on the device. In an alternative implementation, depending on configuration of the device, the first camera may be used to capture the motion of the user's finger. At 304, as the second camera captures the movement of the user's finger, a pointer shown on the display of the device may move across the display accordingly.

At 306, a computer program may cause a processor to determine whether the user has selected an application stored on the device. In one implementation, the processor may determine that an application has been selected when the user taps his or her finger on the second camera. For example, if the user moves his or her finger such that the pointer is located above an instant messaging application, when the user taps his or her finger on the second camera, the processor may be able to determine that the user desires to access the instant messaging application. If the user did not select an application, then the second camera continues to capture the motion of the user's finger and the pointer is moved accordingly.

When the processor determines that the user selected an application, then, at 308, the processor determines whether the user has authorization to access the selected application. Because there may be multiple users on a single device and each user has different levels of access, the processor has to determine whether the current user has access to the selected application. Furthermore, because a user may leave his or her device unlocked and another user may easily access the unlocked device, the processor has to determine whether the current user or another user has authorization to access the selected application. To provide maximum security, the processor may compare the fingerprint of the user that was captured in step 302 with a reference fingerprint of the user to determine whether the user has access to the selected application in certain implementations. In an alternative implementation, the processor may cause the first camera to capture a facial image of the user when the application is selected, and compare the captured facial image with a reference facial image to determine whether the user has access to the selected application. Simultaneously, the processor may cause the second camera to capture the fingerprint of the user when the application is selected, and compare the captured fingerprint with a reference fingerprint to determine whether the user has access to the selected application.

If the user is not authorized to access the selected application, the processor causes the display of the device to display an access denied message at 310. However, if the user is authorized to access the selected application, the processor is configured to launch the selected application on the device. Such a process as illustrated in FIG. 3 provides maximum security on the device, even after the device has been unlocked.

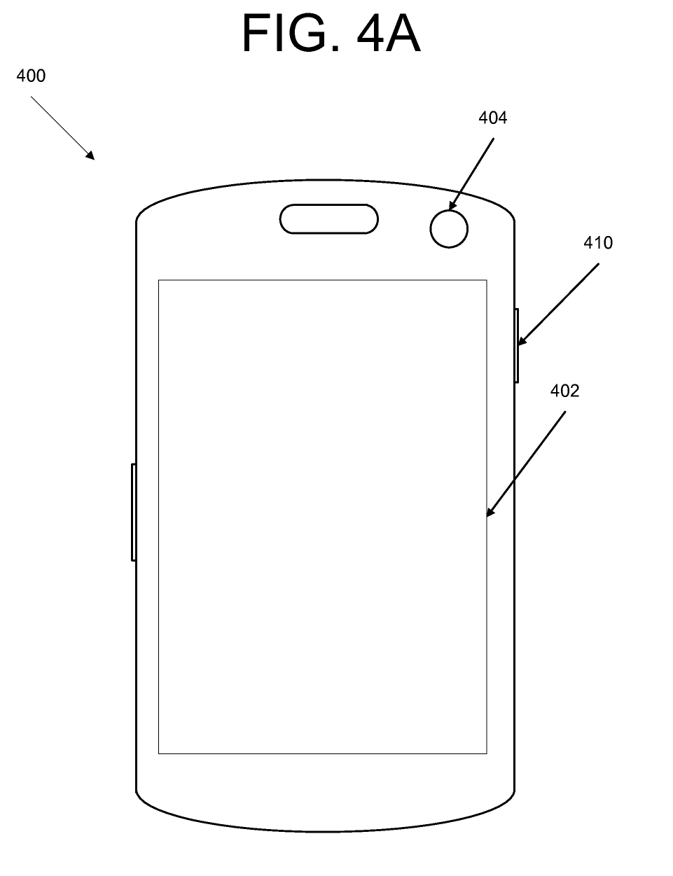

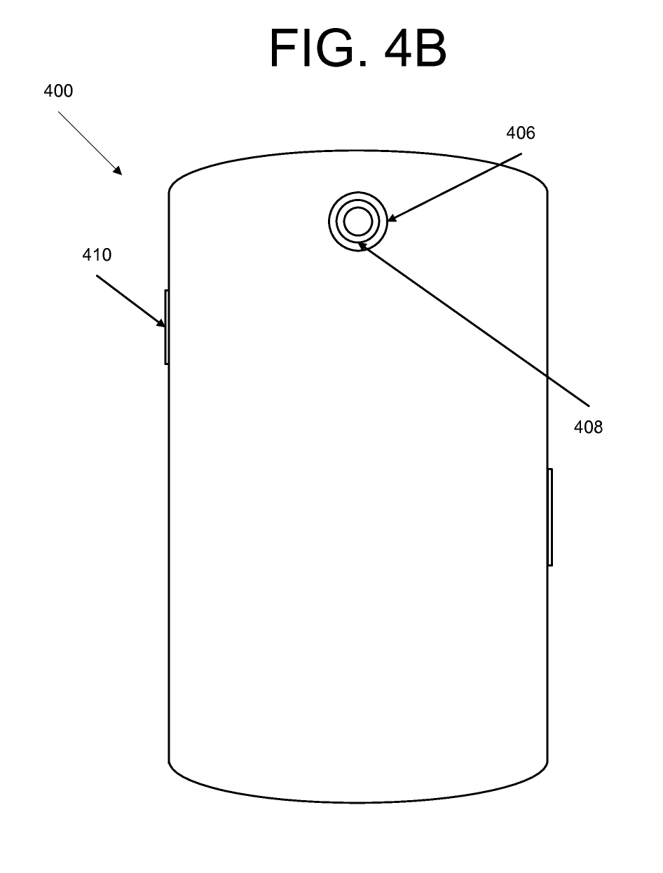

FIGS. 4A and 4B illustrate a device 400, according to an implementation of the present disclosure. Device 400 may be a mobile device, a PDA, or any other device that would be readily appreciated by a person of ordinary skill in the art. In FIG. 4A, a display 402, a camera 404, and an activation button 410 are shown. Activation button 410 may trigger the facial and fingerprint authentication process described herein when a user presses activation button 410. Camera 402 may be configured to capture a facial image of the user and display 402 may be configured to display the facial image of the user prior to, and after, capturing the facial image of the user.

In FIG. 4B, a camera 406 is illustrated. Generally, when a user places his or her fingers on camera 406, the image of the fingerprint may not be clearly visible due to the lack of lighting, or flash, within camera 406. For instance, many devices include lighting or flash near the camera, and thus, when a user places his or her finger near or on the camera, the captured image of the fingerprint may not be clear or visible. To overcome this deficiency, device 400 includes one or more lighting elements, such as LED rings 408, placed within camera 406. In certain implementations, one or more lighting elements, such as LED rings 408, may be included in, near, and/or around camera 406. LED rings 408 allow camera 406 to clearly capture an image of the user's fingerprint when the finger is placed over, or covers, camera 406. For example, as the user places his or her finger on camera 406, or taps camera 406 with his or her finger, LED rings 408 are configured to automatically illuminate such that the fingerprint of the user can be captured.

In certain implementations, camera 406 may be equipped with a touch sensor (not shown) to detect the finger of the user or the motion of the user's finger. The touch sensor may be located within the camera or near the camera. Other implementations may include a multi-touch sensor (also not shown) to detect the user's fingerprint before, during, and after the authentication process to unlock the device.

As mentioned above, once the fingerprint and facial image of the user are captured either simultaneously or sequentially, user authentication can begin so device 400 can be unlocked. Once the user has been authenticated, device 400 is unlocked. However, to provide maximum security on device 400, one or more applications may require facial and/or fingerprint authentication of the user. Such authentication can be completed rather quickly, utilizing camera 402 and/or camera 406 to capture the facial image and/or fingerprint of the user when a particular application is selected.

FIG. 5 illustrates a system 500 for unlocking a device using facial and fingerprint authentication, according to an implementation of the present disclosure. System 500 includes a bus 505 or other communication mechanism for communicating information, and a processor 510 coupled to bus 505 for processing information. Processor 510 may be any type of general or specific purpose processor, including a central processing unit (CPU) or application specific integrated circuit (ASIC). System 500 further includes a memory 515 for storing information and instructions to be executed by processor 510. Memory 515 can be comprised of any combination of random access memory (RAM), read only memory (ROM), flash memory, cache, static storage such as a magnetic or optical disk, or any other types of non-transitory computer-readable media or combinations thereof. Additionally, system 500 includes a communication device 520, such as a wireless network interface card, to provide access to a network.

Non-transitory computer-readable media may be any available media that can be accessed by processor 510 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor 510 is further coupled via bus 505 to a display 525, such as a Liquid Crystal Display (“LCD”), for displaying information to a user. A keyboard 530 and a cursor control device 535, such as a computer mouse, may be coupled to bus 505 to enable a user to interface with system 500.

In one implementation, memory 515 stores software modules that provide functionality when executed by processor 510. The modules include an operating system 540 for system 500. The modules further include an authentication module 545 that is configured to authenticate the user by utilizing the fingerprint and facial image of the user to unlock the device. System 500 may include one or more additional functional modules 550 that include additional functionality. For example, functional modules 550 may include separate modules, such as a fingerprint module to authenticate a user's fingerprint and a facial module to authenticate the user's facial image. Functional modules 550 may also include facial image storage to store reference facial images of the user or users and fingerprint storage to store reference fingerprints of the user or users.

One skilled in the art will appreciate that a “system” could be embodied as a personal computer, a server, a console, PDA, a mobile phone, a tablet computing device, or any other suitable computing device, or combination of devices. Presenting the above-described functions as being performed by a “system” is not intended to limit the scope of the present disclosure in any way, but is intended to provide one example of many implementations of the present disclosure. Indeed, processes, systems and apparatuses disclosed herein may be implemented in localized and distributed forms consistent with computing technology, including cloud computing systems.

It should be noted that some of the system features described in this disclosure have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 1-3 may be performed by a computer program, encoding instructions for the nonlinear adaptive processor to perform at least the processes described in FIGS. 1-3, in accordance with an implementation of the present disclosure. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the processes described in FIGS. 1-3, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an application specific integrated circuit (“ASIC”).

In one implementation, an apparatus may include a first camera configured to capture facial data of a user and a second camera configured to capture fingerprint data of the user. The apparatus may also include a processor configured to authenticate the user of the apparatus based on the captured facial data and fingerprint data, and unlock the apparatus so the user can utilize the apparatus. In certain implementations, based on the fingerprint and/or gesture of the finger, the processor may be configured to execute one or more applications stored on the apparatus.

It will be readily understood that the components of various implementations of the present disclosure, as generally described and illustrated in the figures herein, may be arranged and designed in a wide variety of different configurations. Thus, the detailed description of the implementations of the apparatuses, processes, and computer programs of the present disclosure, as represented in the attached figures, is not intended to limit the scope of the disclosure as claimed, but is merely representative of selected implementations of the present disclosure.

The features, structures, or characteristics of the implementations described throughout this specification may be combined in any suitable manner in one or more implementations. For example, reference throughout this specification to “certain implementations,” “some implementations,” or similar language means that a particular feature, structure, or characteristic described in connection with the implementation is included in at least one implementation of the present disclosure. Thus, appearances of the phrases “in certain implementations,” “in some implementations,” “in other implementations,” or similar language throughout this specification do not necessarily all refer to the same group of implementations and the described features, structures, or characteristics may be combined in any suitable manner in one or more implementations.

It should be noted that reference throughout this specification to features, advantages, or similar language does not imply that all of the features and advantages that may be realized with the present disclosure should be or are in any single implementation. Rather, language referring to the features and advantages is understood to mean that a specific feature, advantage, or characteristic described in connection with an implementation is included in at least one implementation of the present disclosure. Thus, discussion of the features and advantages, and similar language, throughout this specification may, but do not necessarily, refer to the same implementation.

Furthermore, the described features, advantages, and characteristics of the disclosure may be combined in any suitable manner in one or more implementations. One skilled in the relevant art will recognize that the apparatuses, processes, and computer programs can be practiced without one or more of the specific features or advantages of a particular implementation. In other instances, additional features and advantages may be recognized in certain implementations that may not be present in all implementations of the present disclosure.

One having ordinary skill in the art will readily understand that the apparatuses, processes, and computer programs as discussed above may be practiced with steps in a different order, and/or with hardware elements in configurations which are different than those which are disclosed. Therefore, although the disclosure has been described based upon these implementations, it would be apparent to those of skill in the art that certain modifications, variations, and alternative constructions would be apparent, while remaining within the spirit and scope of the disclosure. In order to determine the metes and bounds of the disclosure, therefore, reference should be made to the appended claims.

1. A computer program embodied on computer-readable storage medium, the computer program configured to cause at least one processor to:
capture a facial image of a user utilizing a first camera and a fingerprint of the user utilizing a second camera;
compare the captured facial image with a reference facial image, and the captured fingerprint with a reference fingerprint; and
unlock a device when the captured facial image matches the reference facial image and the captured fingerprint matches the reference fingerprint.

2. The computer program of claim 1, wherein the computer program is further configured to cause the at least one processor to illuminate at least one lighting element to provide lighting when a finger of the user covers the second camera.

3. The computer program of claim 2, wherein the second camera comprises the at least one lighting element.

4. The computer program of claim 1, wherein the computer program is further configured to cause the at least one processor to automatically capture the fingerprint of the user utilizing the second camera when a gesture of a finger of the user is detected.

5. The computer program of claim 1, wherein the computer program is further configured to cause the at least one processor to automatically capture the fingerprint of the user utilizing the second camera when a motion of a finger of the user is detected.

6. The computer program of claim 1, wherein the computer program is further configured to cause the at least one processor to automatically capture the fingerprint of the user utilizing the second camera when a finger of the user is in contact with the second camera.

7. The computer program of claim 1, wherein the computer program is further configured to cause the at least one processor to perform a function on the device based on a gesture or motion of a finger of the user.

8. The computer program of claim 1, wherein the computer program is further configured to cause the at least one processor to allow access to at least one application on the device based on the captured fingerprint of the user, the facial image of the user, or both.

9. The computer program of claim 1, wherein the computer program is further configured to cause a display of the device to present certain at least one application based on the fingerprint of the user, the facial image of the user, or both.

10. The computer program of claim 1, wherein the computer program is further configured to cause the at least one processor to capture the facial image of the user utilizing the first camera and the fingerprint of the user utilizing the second camera simultaneously.

11. A computer-implemented process, comprising:
capturing, by a device, a fingerprint of a user and a facial image of the user;
authenticating, by the device, the user based on the captured fingerprint and the facial image of the user; and
unlocking the device when the captured fingerprint and the facial image of the user are authenticated.

12. The computer-implemented process of claim 11, further comprising:
detecting the fingerprint prior to capturing the fingerprint.

13. The computer-implemented process of claim 12, wherein the capturing of the fingerprint and the facial image of the user comprises:
automatically capturing the fingerprint and the facial image of the user upon detection of the fingerprint.

14. The computer-implemented process of claim 11, wherein the authenticating of the user comprises:
comparing the captured facial image with a reference facial image, and comparing the captured fingerprint with a reference fingerprint.

15. The computer-implemented process of claim 11, further comprising:
unlocking the device and performing a function on the device based on the captured fingerprint of the user.

16. The computer-implemented process of claim 11, further comprising:
continuously capturing a motion of the user's finger when the device is unlocked; and
moving a pointer across a display of the device based on the continuous motion of the user's finger.

17. The computer-implemented process of claim 16, further comprising:
determining whether the user is authorized to access a particular application when the user selects the particular application.

18. The computer-implemented process of claim 17, wherein the determining of whether the user is authorized comprises:
capturing a facial image of the user and a fingerprint of the user when the particular application is selected;
comparing the captured facial image of the user with the reference facial image and comparing the captured fingerprint of the user with the reference fingerprint; and
launching the selected particular application when the captured facial image and the captured fingerprint of the user are authenticated.

19. The computer-implemented method of claim 11, wherein the fingerprint of the user and the facial image of the user are captured simultaneously.

20. An apparatus, comprising:
physical memory comprising computer program instructions; and
at least one processor configured to execute the computer program instructions, the at least one processor configured to:
capture a fingerprint of a user and a facial image of the user;
authenticate the user based on the captured fingerprint and the facial image of the user; and
unlock the apparatus when the captured fingerprint and the facial image of the user are authenticated.

21. The apparatus of claim 20, wherein the at least one processor is further configured to:
detect the fingerprint prior to capturing the fingerprint.

22. The apparatus of claim 21, wherein the at least one processor is further configured to:
automatically capture the fingerprint and the facial image of the user upon detection of the fingerprint.

23. The apparatus of claim 20, wherein the at least one processor is further configured to:
compare the captured facial image with a reference facial image, and compare the captured fingerprint with a reference fingerprint.

24. The apparatus of claim 20, wherein the at least one processor is further configured to:
unlock the device and perform a function on the device based on the captured fingerprint of the user.

25. The apparatus of claim 20, wherein the at least one processor is further configured to:
continuously capture a motion of the user's finger when the device is unlocked; and
move a pointer across a display of the device based on the continuous motion of the user's finger.

26. The apparatus of claim 25, wherein the at least one processor is further configured to:
determine whether the user is authorized to access a particular application when the user selects the particular application.

27. The apparatus of claim 26, wherein the at least one processor is further configured to:
capture a facial image of the user and a fingerprint of the user when the particular application is selected;
compare the captured facial image of the user with the reference facial image and compare the captured fingerprint of the user with the reference fingerprint; and
launch the selected particular application when the captured facial image and the captured fingerprint of the user are authenticated.

28. The apparatus of claim 20, wherein the at least one processor is further configured to capture the fingerprint of the user and the facial image of the user simultaneously.

29. A computer-implemented process, comprising:
capturing, by a device, a gesture of a user's finger, and a facial image of the user;
authenticating, by the device, the user based on the captured gesture and the facial image of the user; and
unlocking the device when the captured gesture and the facial image of the user are authenticated.

30. The computer-implemented process of claim 29, further comprising:
continuously capturing a motion of the user's finger when the device is unlocked; and
moving a pointer across a display of the device based on the continuous motion of the user's finger.

31. The computer-implemented process of claim 29, further comprising:
determining whether the user is authorized to access a particular application when the user selects the particular application.

32. The computer-implemented process of claim 31, wherein the determining of whether the user is authorized comprises:
capturing a facial image of the user and a fingerprint of the user when the particular application is selected;
comparing the captured facial image of the user with the reference facial image and comparing the captured fingerprint of the user with the reference fingerprint; and
launching the selected particular application when the captured facial image and the captured fingerprint of the user are authenticated.

33. An apparatus, comprising:
physical memory comprising computer program instructions; and
at least one processor configured to execute the computer program instructions, the at least one processor configured to:
capture a gesture of a user's finger and a facial image of the user;
authenticate the user based on the captured gesture and the facial image of the user; and
unlock the apparatus when the captured gesture and the facial image of the user are authenticated.

34. The apparatus of claim 33, wherein the at least one processor is further configured to:
continuously capture a motion of the user's finger when the device is unlocked; and
move a pointer across a display of the device based on the continuous motion of the user's finger.

35. The apparatus of claim 33, wherein the at least one processor is further configured to:
determine whether the user is authorized to access a particular application when the user selects the particular application.

36. The apparatus of claim 35, wherein the at least one processor is further configured to:
capture a facial image of the user and a fingerprint of the user when the particular application is selected;
compare the captured facial image of the user with the reference facial image and compare the captured fingerprint of the user with the reference fingerprint; and
launch the selected particular application when the captured facial image and the captured fingerprint of the user are authenticated.
